(19) United States
(12) Patent Application Publication
(10) Pub. No.: US 2003/0039410 A1
(43) Pub. Date: Feb. 27, 2003

(54) System and method for facilitating image retrieval

(76) Inventors: Edward S. Beeman, Windsor, CO (US); Gordon R. Nuttall, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 09/938,256

(22) Filed: Aug. 23, 2001

(51) Int. Cl. G06F 7/00; G06F 17/30; G06K 9/54; G06K 9/60

(52) U.S. Cl. 382/305; 707/3

(57) ABSTRACT

The present disclosure relates to a system and method for facilitating image retrieval. In one arrangement, the method comprises the steps of querying a user as to at least one attribute of an image the user wishes to retrieve, receiving user responses, and presenting at least one image to the user based upon the user response. In one arrangement, the system comprises means for querying a user as to attributes of an image the user wishes to retrieve, means for receiving user responses, and means for presenting images to the user based upon the user responses.

### FIELD OF THE INVENTION

The present disclosure relates to image retrieval. More particularly, the disclosure relates to a system and method for facilitating image retrieval.

### BACKGROUND OF THE INVENTION

Currently, there are many different image capture devices that are configured for capturing and storing digital images (still or video). Examples include digital cameras and digital video recorders that capture actual, real time scenes, and scanners that digitally capture existing images such as film-based photographs. Although several existing image capture devices can, at least temporarily, store images within device memory, users normally store the captured images in a local or remote database. For instance, the user may store captured images within a hard drive of the user's personal computer (PC) or may store the captured images within an online archive that is accessible over the Internet.

Users often store each image in the database using a filename that is somehow relevant to the content of the image. For instance, where the image is a photograph of a person named “Joe” and was taken on his birthday, the user may save the image as “joe_birthday” or equivalent. By saving the image with a descriptive filename, the user will be more likely to later locate the image when it is desired. Unfortunately, where the user stores many different images in the database, this method of identification and retrieval can be ineffective because of the limited amount of information that can be provided in the filename.

Due to the limitations associated with the aforementioned storage and retrieval method, users often further (or alternatively) store the images in different directories within the database. For example, the user may maintain “family,” “friends,” “business,” and “vacation” directories that contain images that pertain to these subjects. In such an arrangement, the user can narrow the field of search for an image he or she is looking for and then scroll through the image filenames in hopes of locating the desired image. This method of storage and retrieval can also be disadvantageous. First, the user must exercise great care when storing the images to ensure that one or more images are not filed under the wrong directory. Therefore, the storage process can be tedious for the user. In addition, several images may qualify for placement in more than one directory. For instance, the image may be of a family member that was taken on vacation. In such situations, the user must either devise some standards to apply to determine which single directory in which to store the image, or must ensure that the image is stored in each applicable directory.

To avoid the situation in which the user must seek out an image by filename alone, some users further use thumbnail viewers with which each of the photographs of a particular database and/or directory can be viewed, either in groups or by scrolling through all the images. Although this method can save the user much time in locating a desired image, it too can be tedious for the user, particularly where the database and/or directory contains many hundreds of images. Furthermore, in that the images are normally only presented as low resolution thumbnails, it is easy for the user to pass over the desired image without noticing it.

In yet a further scenario, the user can associate keywords with an image such that the user can later provide the keywords to a search engine when attempting to retrieve the image. Although this method is superior to the aforementioned methods in several ways, it too has its limitations in that the effectiveness of the search engine is limited by the skill and diligence of the user in creating the keywords when the image is stored. In addition, the search engine is static and is therefore incapable of later collecting more information from the user that could be used to improve its ability to find the image.

### SUMMARY OF THE INVENTION

From the foregoing, it can be appreciated that it would be desirable to have a system and method for facilitating image retrieval that avoids one or more of the drawbacks identified above. The present disclosure provides such a system and method.

In one arrangement, the method comprises the steps of querying a user as to at least one attribute of an image the user wishes to retrieve, receiving user responses, and presenting at least one image to the user based upon the user response.

In one arrangement, the system comprises means for querying a user as to attributes of an image the user wishes to retrieve, means for receiving user responses, and means for presenting images to the user based upon the user responses.

In a preferred embodiment, the system and method are adapted to receive information from the user during the retrieval process so that the system can become more proficient at recognizing image attributes and, therefore, at locating and retrieving images.

### BRIEF DESCRIPTION OF THE DRAWINGS

The invention can be better understood with reference to the following drawings. The components in the drawings are not necessarily to scale, emphasis instead being placed upon clearly illustrating the principles of the invention.

FIG. 1 is a schematic view of a system for facilitating image retrieval according to the present invention.

FIG. 2 is a schematic view of an image capture device shown in FIG. 1.

FIG. 3 is a schematic view of a computing device shown in FIG. 1.

FIG. 4 is a flow diagram that illustrates an example of the operation of an image retrieval module shown in FIG. 2 during an image storage process.

FIG. 5 is a schematic representation of associations created during an image storage process of the present invention.

FIGS. 6A-6C provide a flow diagram that illustrates an example of the operation of the image retrieval module shown in FIG. 2 during an image retrieval process according to the present invention.

FIG. 7 is a schematic representation of an example method for identifying an image attribute to the image retrieval module according to the present invention.

### DETAILED DESCRIPTION

As noted above, current image retrieval systems and methods present several drawbacks to the user. Accordingly, it is presently contemplated to provide an image retrieval system and method that avoids these drawbacks. More specifically, contemplated is a system and method that can collect information from the user during the retrieval process so as to become more proficient at locating images. An example system for practicing the methods will first be discussed followed by examples as to how the system operates and how it can be used to retrieve images.

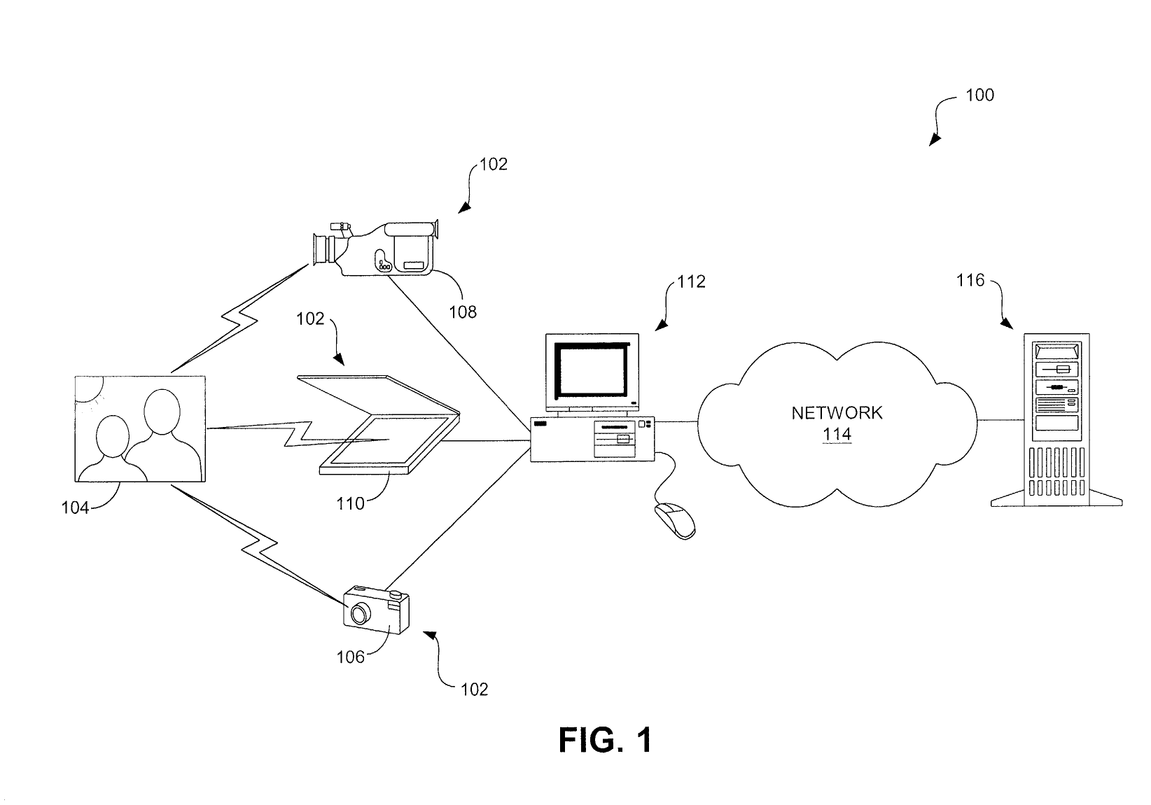

Referring now to the drawings, in which like numerals indicate corresponding parts throughout the several views, FIG. 1 illustrates a system 100 for facilitating image retrieval according to the present invention. As indicated in this figure, the system 100 can comprise one or more image capture devices 102 that can be used to capture an image 104 that typically either comprises an actual, real time scene or an existing image such as a photograph. The nature of the image capture devices 102 can vary. By way of example, the image capture devices 102 can comprise a digital camera 106, a digital video recorder 108, and a scanner 110. Although these particular image capture devices are illustrated in FIG. 1 and are specifically identified herein, persons having ordinary skill in the art will appreciate that the teachings contained within this disclosure pertain to substantially any device that is capable of capturing image data.

As is further indicated in FIG. 1, each of the image capture devices 102 can be connected to a first computing device 112. As shown in FIG. 1, each device 102 can be connected by hardware. Alternatively, wireless communications could be used. The first computing device 112 can comprise a personal computer (PC) or substantially any other computing device that can receive image data from an image capture device 102. In some arrangements, the first computing device 112 can be connected (directly or wirelessly) to a network 114 such that the first computing device 112 can communicate with a second computing device 116 that is likewise connected to the network. The network 114 can comprise one or more sub-networks that are communicatively coupled to each other. By way of example, these networks can include one or more local area networks (LANs) and/or wide area networks (WANs). Typically, however, the network 114 comprises a set of networks that forms part of the Internet. As indicated in FIG. 1, the second computing device 116 can comprise a network server. Although a network server is described and shown, it is to be appreciated that the server is provided as an example only and that this representation is not intended to limit the scope of the present disclosure.

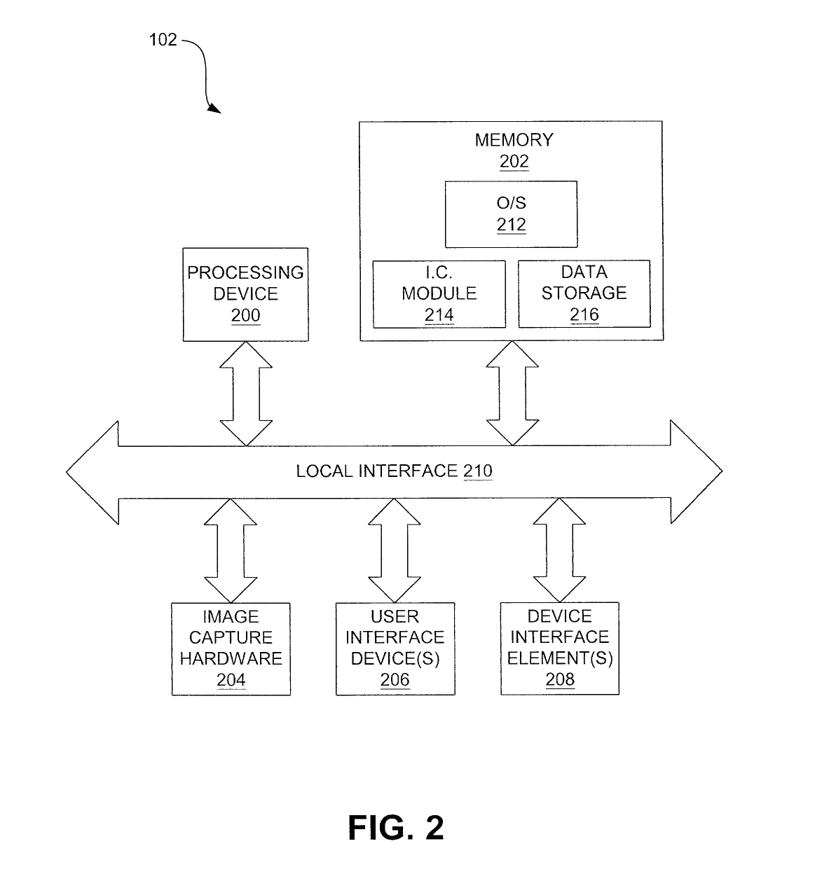

FIG. 2 is a schematic view illustrating an example architecture for the image capture devices 102 shown in FIG. 1. As noted above, the nature of the image capture devices 102 can vary widely. Generally speaking, however, each image capture device 102 typically comprises a processing device 200, memory 202, image capture hardware 204, one or more user interface devices 206, and one or more device interface elements 208. Each of these components is connected to a local interface 210 that, by way of example, comprises one or more internal buses. The processing device 200 is adapted to execute commands stored in memory 202 and can comprise a general-purpose processor, a microprocessor, one or more application-specific integrated circuits (ASICs), a plurality of suitably configured digital logic gates, and other well known electrical configurations that comprise discrete elements both individually and in various combinations to coordinate the overall operation of the image capture device 102.

The image capture hardware 202 comprises the various components used to retrieve and store digital images. Where the image capture device 102 comprises a digital still camera or digital video recorder the image capture hardware 202 can comprise a lens, one or more focusing elements (lenses, mirrors, etc.), one or more light sensing elements (e.g., charge-coupled device (CCD)), etc. Alternatively, where the image capture device 102 comprises a scanner, the image capture hardware 202 can generally comprise a platen, optical sensor, focusing mechanism, etc.

The one or more user interface devices 206 typically comprise interface tools with which image capture device settings can be changed and through which the user can communicate commands to the device 102. By way of example, the user interface devices 206 can comprise one or more function keys with which the operation of the image capture device 102 can be controlled and a display that is adapted to communicate graphical information to the user (e.g., a liquid crystal display (LCD)). The one or more device interface elements 208 are adapted to facilitate electrical connection with another device, such as the first computing device 112 and, if the image capture device 102 is network-enabled, to facilitate connection to the network 114. In either case, the interface elements 208 normally comprise a data transmitting/receiving device and/or one or more communication ports.

The memory 202 includes various software and/or firmware programs including an operating system 212 and an image capture module 214. The operating system 212 contains the various commands used to control the general operation of the image capture device 102. The image capture module 214 comprises software and/or firmware that is adapted to, in conjunction with the image capture hardware 204, capture data that can be stored by the image capture device 102 in data storage 216 and/or transmitted to another device (e.g., computing devices 112, 116) for storage.

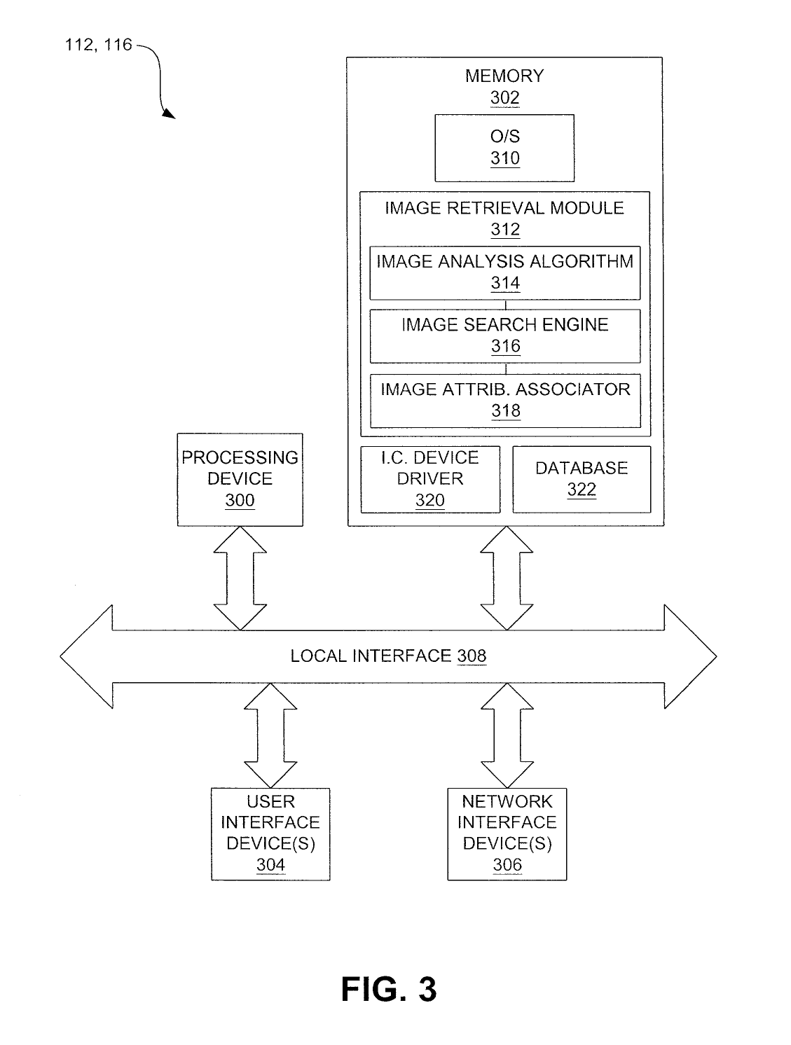

FIG. 3 is a schematic view illustrating an example architecture for the computing devices 112 and 116 that, as is described below, can be used to store images and configure them for later retrieval. As indicated in FIG. 3, each computing device 112, 116 can comprise a processing device 300, memory 302, one or more user interface devices 304, one or more network interface devices 306, and a local interface 308 to which each of the other components electrically connects. The local interface 308 may have additional elements, which are omitted for simplicity, such as controllers, buffers (caches), drivers, repeaters, and receivers to enable communications. Furthermore, the local interface 308 may include address, control, and/or data connections to enable appropriate communications among the aforementioned components.

The processing device 300 can include, and not by way of limitation, any custom made or commercially available processor, a central processing unit (CPU) or an auxiliary processor among several processors associated with the computing device 112, 116, a semiconductor based microprocessor (in the form of a microchip), or a macroprocessor. The memory 302 can include, and not by way of limitation, any one of a combination of volatile memory elements (e.g., random access memory (RAM, such as DRAM, SRAM, etc.)) and nonvolatile memory elements (e.g., ROM, hard drive, tape, CDROM, etc.).

The user interface devices 304 typically comprise those normally used in conjunction with a computing device. For instance, the user interface devices 304 can comprise a keyboard, mouse, monitor, etc. The one or more network interface devices 306 comprise the hardware with which the computing device 112, 116 transmits and receives information over the network 114. By way of example, the network interface devices 306 include components that communicate both inputs and outputs, for instance, a modulator/demodulator (e.g., modem), a radio frequency (RF) or other transceiver, a telephonic interface, a bridge, a router, etc.

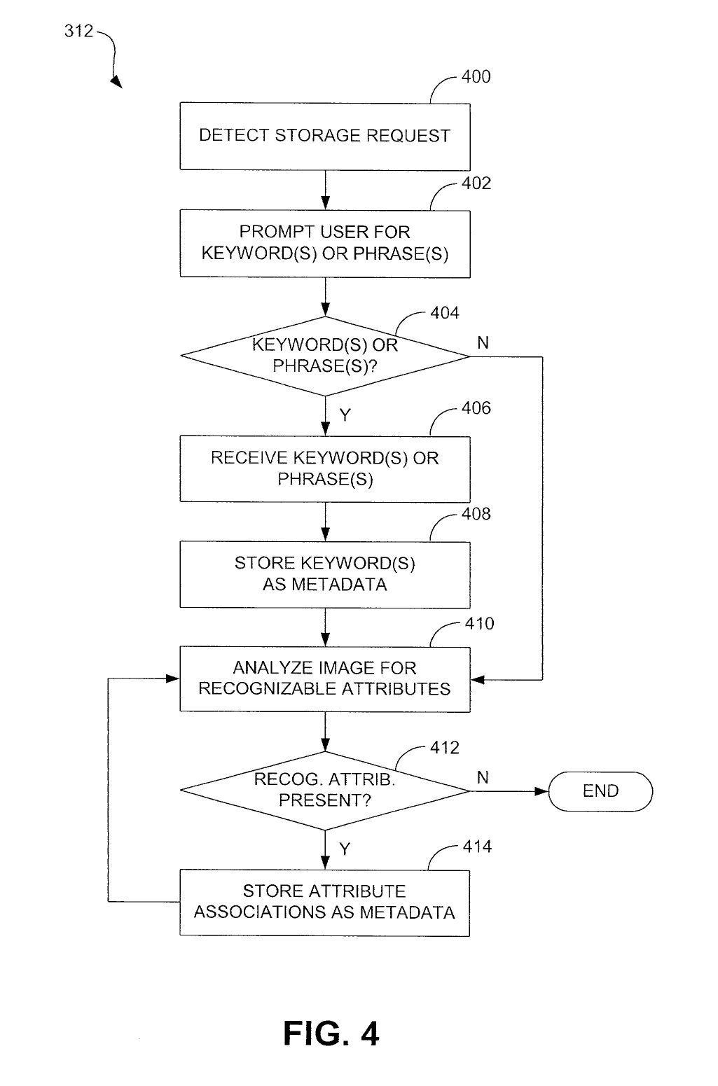

The memory 302 comprises various software programs including an operating system 310, an image retrieval module 312, an image capture device driver 320, and a database 322. The operating system 310 controls the execution of other software, such as the image retrieval module 312, and provides scheduling, input-output control, file and data management, memory management, and communication control and related services. As indicated in FIG. 3, the image retrieval module 312 can comprise various submodules. For instance, the image retrieval module 312 can comprise an image analysis algorithm 314 that is used to analyze images, an image search engine 316 that is used to locate and retrieve stored images, and an image attribute associator 318 that can be used to make image attribute associations that improve the proficiency of the search engine. Although separate submodules have been identified in FIG. 3, persons having ordinary skill in the art will recognize that these submodules represent various functionalities performed by the image capture module 312 and that the submodules therefore can be combined or arranged alternatively. Examples of the operation of the image capture module 312 are provided below with reference to FIGS. 4-7.

Further included in the memory 302 is an image capture device driver 320 that is used to communicate with and control (where applicable) the image capture devices 102. Alternatively, in so-called “driverless” systems, the image capture device driver 320 may not be needed. The memory 302 normally includes a database 322 that can be used to store image data and, as is discussed in greater detail below, metadata that can be used by the image retrieval module 312 to locate and retrieve images.

Various software and/or firmware programs have been described herein. It is to be understood that these programs can be stored on any computer readable medium for use by or in connection with any computer related system or method. In the context of this document, a computer readable medium is an electronic, magnetic, optical, or other physical device or means that can contain or store a computer program for use by or in connection with a computer related system or method. These programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a nonexhaustive list) of the computer-readable medium include an electrical connection having one or more wires, a portable computer diskette, a random access memory (RAM), a read-only memory (ROM), an erasable programmable read-only memory (EPROM, EEPROM, or Flash memory), an optical fiber, and a portable compact disc read-only memory (CDROM). Note that the computer-readable medium can even be paper or another suitable medium upon which a program is printed, as the program can be electronically captured, via for instance optical scanning of the paper or other medium, then compiled, interpreted or otherwise processed in a suitable manner if necessary, and then stored in a computer memory.

An example system 100 having been described above, operation of the system will now be discussed. In the discussion that follows, several flow diagrams are provided. It is to be understood that any process descriptions or blocks in these flow diagrams represent modules, segments, or portions of code which include one or more executable instructions for implementing specific logical functions or steps in the process and that alternative implementations are feasible. Moreover, functions may be executed out of order from that shown or discussed, including substantially concurrently or in reverse order, depending on the functionality involved.

Referring now to FIG. 4, an example of operation of the image retrieval module 312 during the image storing process according to the present invention will be discussed. As is will be apparent from later discussions provided herein, the image retrieval module's participation in the storage process can result in improved retrieval capability. As indicated in block 400, the image retrieval module 312 first detects a storage request. By way of example, this request can be a request to store a captured image (e.g., digital photograph, digital video frame, or scanned image) in the local or remote database 322. Once this request has been detected, the image retrieval module 312 can prompt the user for keywords or phrases that are relevant to the content of the image and that the user can later enter in a search engine when attempting to retrieve the image from the database 322. For instance, if the image comprises a picture of Joe's birthday party, the user may enter “Joe,” “birthday,” and “party” as keywords or the phrase “Joe at his birthday party.”

With reference to decision element 404, if the user does wish to provide keywords or phrases, flow continues to block 406 at which the keywords or phrases are received. If the user does not wish to provide keywords and/or phrases, however, flow continues down to block 410 described below. Once the keywords or phrases have been received, the provided keywords, or keywords extracted from the provided phrase, are stored as image metadata, as indicated in block 408. For instance, if the user provided the phrase “Joe at his birthday party,” the image retrieval module 312 can store the terms “joe,” “birthday,” and “party” as individual search terms. As will be appreciated by persons having ordinary skill in the art, the metadata can be stored as part of the image file that will be created in the storage process such that the file will contain both image data and metadata, or can be stored separately in a lookup table that correlates the keywords with the specific image files.

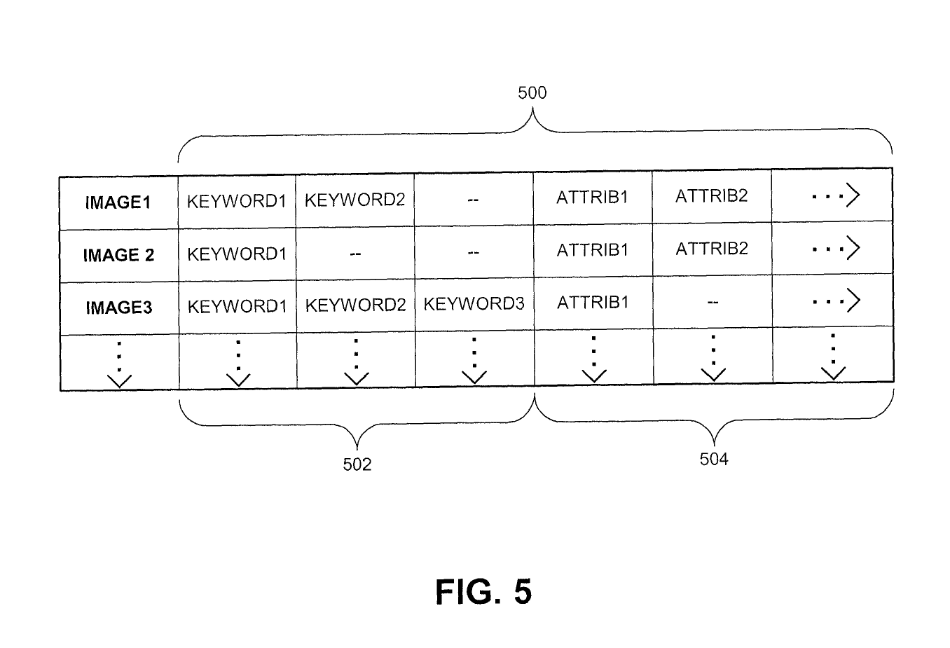

Referring next to block 410, the image retrieval module 312 can analyze the image to be stored for recognizable attributes. Specifically, the image analysis algorithm 314 of the image retrieval module 312 can analyze the image in relation to stored attribute associations. By way of example, the image analysis algorithm 314 can be preconfigured to recognize certain image attributes that pertain to sunlight, the sky, grass, trees, bodies of water, incandescent light, florescent light, human beings, human faces, animals, etc. Persons having ordinary skill in the art will understand that such recognition can be based upon color spectra, light spectra, object edges, object aspect ratios, position in the image, and so forth. With such stored attribute associations, the image retrieval module 312 can further add to the metadata associated with the image by noting attributes of the image (e.g., by adding a metadata tag) that the user may not have identified with the keywords or phrases that he or she provided (if any). FIG. 5 schematically illustrates images and their associated metadata. As indicated in this figure, each stored image (image1, image2, . . . ) can comprise metadata 500 including one or more keywords (keyword1, keyword2, . . .) and one or more identified attributes (attrib1, attrib2, . . . ).

With reference to decision element 412 of FIG. 4, if a recognizable attribute is present in the image, flow continues to block 414 at which an attribute association is stored as metadata, for instance by the image attribute associator 318. Once this association has been stored, flow can return to block 410 at which the image retrieval module 312 can analyze the image for other recognizable attributes. Accordingly, the image retrieval module 312 may find multiple image attributes that increase the module's image retrieval proficiency. With reference back to decision element 412, if no (or no more) image attributes are identified, flow is terminated and the image file is stored in the database 322.

After an image has been stored, for instance using the procedure described above in relation to FIGS. 4 and 5, the user can retrieve the image from the database 322. Where the database 322 comprises a large number of images, it may be difficult for the user to quickly locate the desired image. However, the image retrieval module 312, and more particularly the image search engine 316, can be used to simplify the retrieval process. As is discussed below, the image retrieval module 312 is configured such that it can obtain information from the user during the retrieval process and store further attribute associations as metadata that will aid in later retrieval procedures. Accordingly, the image retrieval module 312 is dynamically configured so as to become more proficient through the image retrieval process.

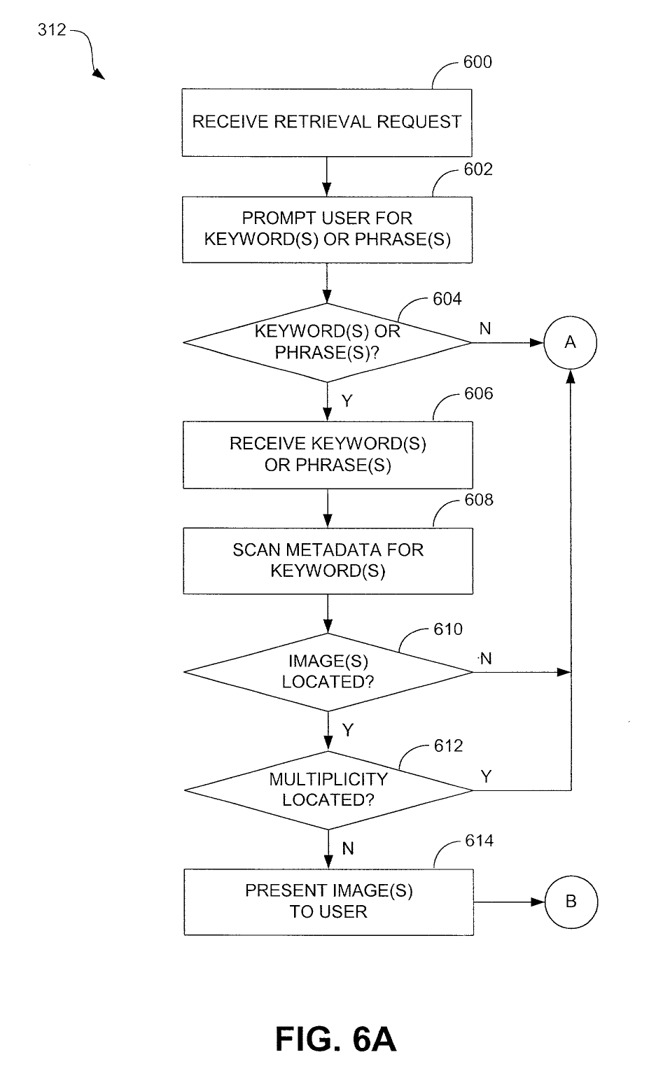

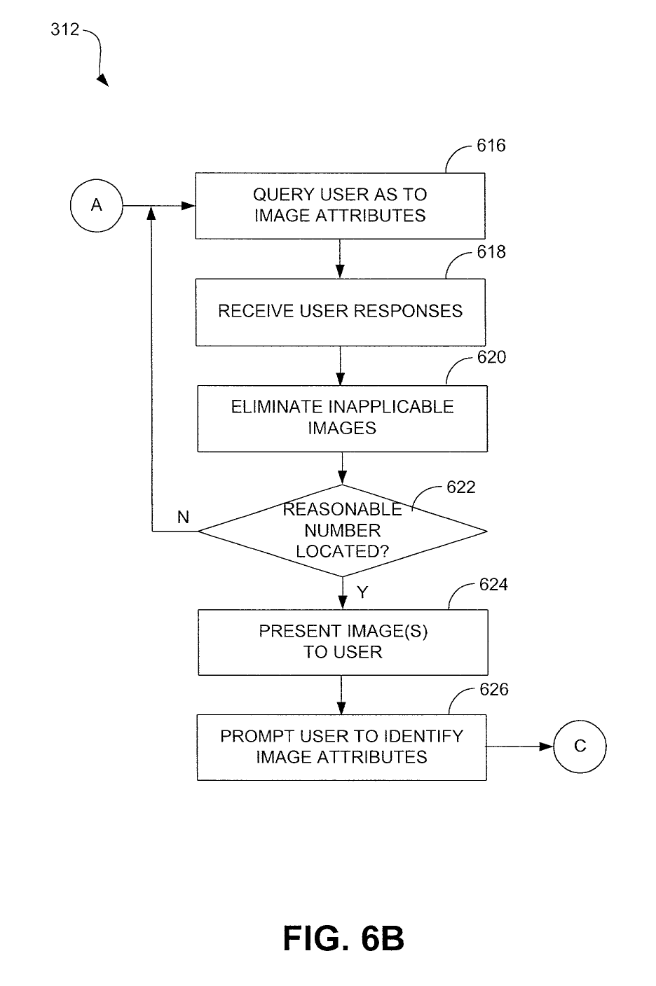

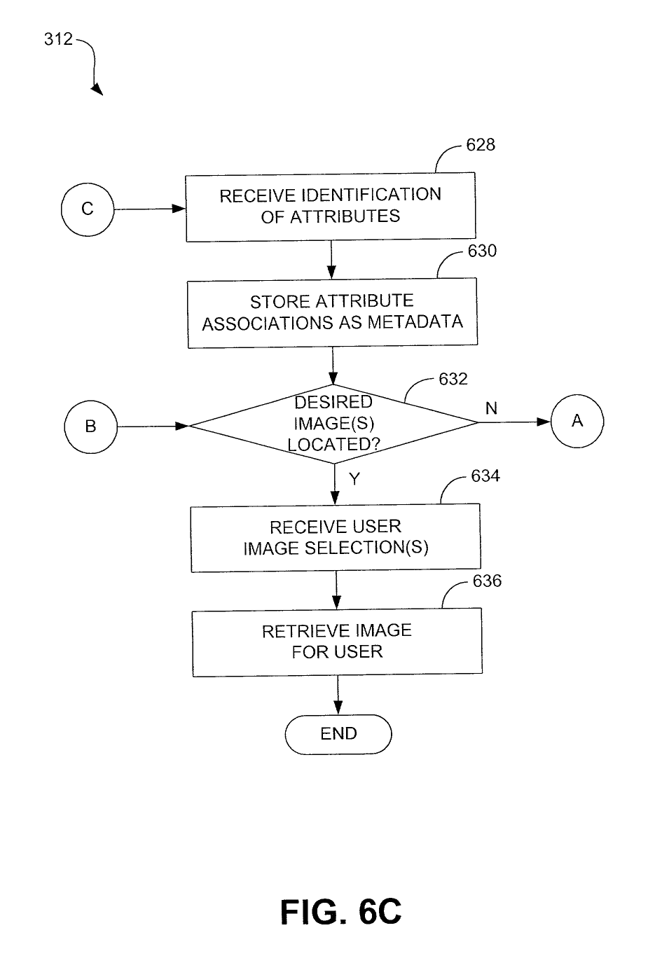

Referring now to FIG. 6A, the image retrieval module 312 can receive a retrieval request, as indicated in block 600. By way of example, this retrieval request can be received by the image search engine 316, which can comprise an application with which the user can interface and submit search requests. Once the search request is received, the image retrieval module 312 can prompt the user for the keywords or phrases that the user believes he or she may have provided in the storage process. As will be appreciated from the discussion that follows, this step is optional in that the image retrieval module 312 is capable of facilitating image retrieval in other ways. With reference to decision element 604, if no keywords or phrases are provided by the user, flow continues to block 616 in FIG. 6B described below. If, however, the user does provide keywords or phrases, flow continues to block 606 at which the keywords or phrases are received by the image retrieval module 312. Once these keywords or phrases are received, the module 312 can scan the image files and, more particularly, the metadata associated with these files, for the keywords provided by the user, as indicated in block 608.

If, as indicated in decision element 610, one or more images are located by the image retrieval module 312, flow continues to decision element 612 at which it can be determined whether a multiplicity (e.g., more than 50) of images have been located or whether only one or a few images have been located. It will be appreciated that what constitutes a “multiplicity” will vary and, in some embodiments, may be selectable by the user. Where only one of a few images are located, flow can continue to block 614 at which the images can be presented to the user (e.g., in thumbnail form). Once presented to the user, flow can then continue on to decision element 632 of FIG. 6C described below.

Referring back to decision element 612 in FIG. 6A, if a multiplicity of images are located by the image retrieval module 312 after scanning for the keywords, flow continues to block 616 shown in FIG. 6B. As indicated in block 616, the image retrieval module 312 can be configured to query the user as to attributes of the image for which the user is looking where no keywords or phrases were provided (decision element 604), where no images were located using provided keywords (decision element 610), or where a multiplicity of images were located using the provided keywords (decision element 612). In each of these scenarios, the image retrieval module 312 has not narrowed the search field with great efficiency. Although the query is described as being directed to the user in these particular scenarios, the image retrieval module 312 can, alternatively, be configured to begin the image retrieval process by querying the user, if desired. Furthermore, it will be appreciated that the user could, optionally, activate the query process at any time, if desired.

The query can comprise one or a series of questions that are posed to the user that are used to narrow the search field for the desired image. By way of example, the questions can begin fairly broadly and become more and more specific with each new posed question. Moreover, the nature of each follow-up question presented to the user can be dependent upon the response the user provided to the previously posed question. For instance, the first question can be “Is the image of an outdoor or indoor scene?” If, for example, the user responds that the image is of an outdoor scene, the second question can be “Was the image taken at day or night?” Other follow-up questions could be “Are there people in the image?” “Is the image a close-up shot?” etc. The responses to these questions can be used to eliminate certain images as potential matches based upon the image attributes they do not contain. For instance, if the user indicates the image is of an indoor scene, the image retrieval module 312 can eliminate all outdoor images from the pool of potential matches. Stated in the alternative, potential matches can be selected based upon image attributes they do contain.

The user responses are received, as indicated in block 618, one by one and, as indicated in block 620, various images are eliminated. Specifically, the image retrieval module 312 scans the metadata associated with the images to determine which images contain the wrong and/or right image attributes. With reference to decision element 622, it can then be determined whether a reasonable number of potential images was located (e.g. twenty). What constitutes a “reasonable” number can vary and, in some embodiments, can be specified by the user. If a reasonable number is not located (i.e., too may are located), flow can return to block 616 and the query process can continue to further narrow the search field. Where a reasonable number of images was located, however, flow continues to block 624 at which the images are presented to the user (e.g., in thumbnail form).

At this point, so as to increase the image retrieval module's proficiency, the image retrieval module 312 can prompt the user to identify image attributes contained in the images presented to the user, as identified in block 626. This identification can be communicated in several different ways. In one arrangement, the identification can comprise selection of images presented to the user which contain a particular attribute in common with the image for which the user was looking or in common with each other. For example, the user could select all images that include a picture of a particular person. Through such selection, the image retrieval module 312 can associate all images comprising this attribute with each other and/or with the responses provided by the user during the query process.

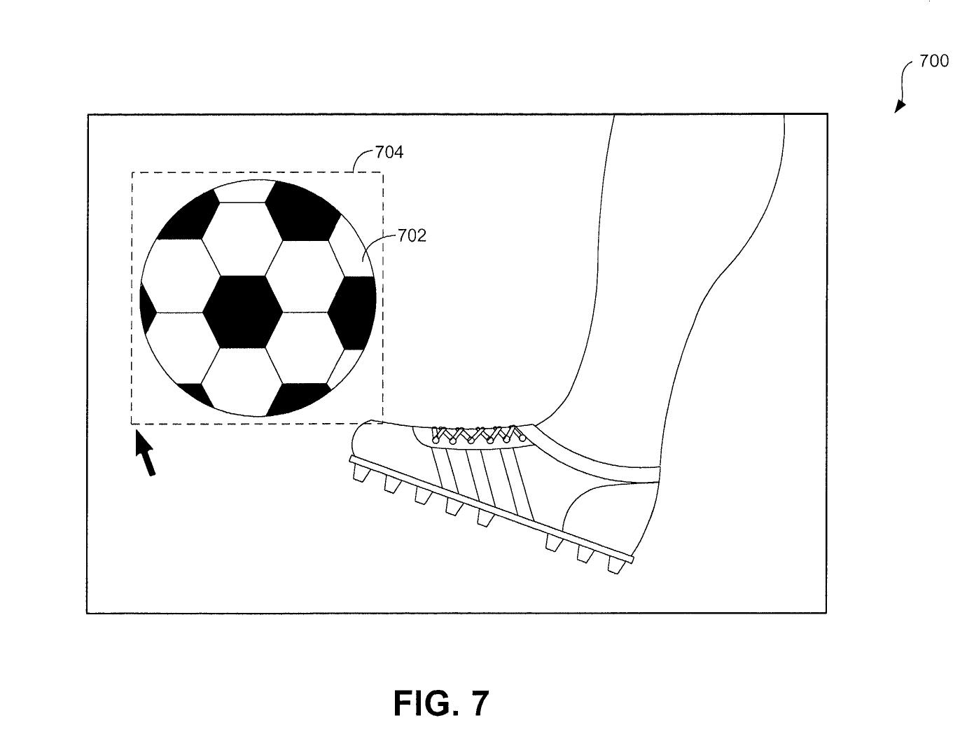

In that the identification method described above is somewhat intuitive, the user may wish to provide a more direct identification of an image attribute. For instance, assuming the user was searching for an image of a soccer game, the user could highlight a soccer ball present in one or more of the images that have been presented to the user. This is schematically illustrated in FIG. 7, which shows an example image 700 that includes a soccer ball 702. As indicated in this figure the user can select the soccer ball 702 with a highlight box 704 using a mouse or other user interface device. After the soccer ball 702 has been highlighted in the manner shown in FIG. 7, the user can explicitly identify the soccer ball as representing “soccer” or a “soccer ball” to the image retrieval module 312. The image retrieval module 312 can therefore learn to associate a round object with black and white patches as being linked to the terms “soccer” or “soccer ball” such that when these terms are received from the user as a keyword or in response to a posed question, the image retrieval module 312 can locate all images that include a soccer ball. Depending upon the sophistication of the image retrieval module 312, the module could be trained in this manner to recognize substantially any image feature or object within an image.

Returning to block 626 and FIG. 6B, once the user has been prompted to identify image attributes, the image retrieval module 312 can receive the identifications, as indicated in block 628 of FIG. 6C. At this point, the attribute associations can be stored as metadata by, for instance, the image attribute associator 318. By way of example, where the user identified the soccer ball 702 to the image retrieval module 312, the existence of the soccer ball can be noted in the metadata (e.g., as a metadata tag) associated with the image 700. In addition, the image retrieval module 312 can be configured to search the entire database of images to identify every image containing this attribute and store this information in the metadata of those images.

At this point, it can be determined whether the desired image or images have been located by the image retrieval module 312, as indicated in decision element 632. If not, flow can return to block 616 at which further questions are posed to the user and the above-described process is repeated. In such a situation, the retrieval process (as well as the image retrieval module learning process) can be iterative in nature. Alternatively, conventional image retrieval techniques can be used to locate the image and, if desired, the image retrieval module 312 taught to recognize one or more attributes within the image in the manner described above. If the image or images have been located, however, flow continues to block 634 at which the user's image selection is received, and block 636 at which the image is retrieved for the user. Again, the user can identify image attributes to the image retrieval module 312 at this point, if desired, so that the image, and other images containing the identified attributes, can be located with greater ease in the future. At this point, retrieval flow is terminated and the process can be repeated to locate and retrieve other images.

From the above description, it will be appreciated that the more frequently the retrieval process, and the information exchange that takes place during it, is undergone, the more proficient the image retrieval module 312 can become. Therefore, more advantageous results can be achieved with the image retrieval module 312 as compared with conventional image retrieval software packages.

What is claimed is:

1. A method for facilitating image retrieval, comprising the steps of:
querying a user as to at least one attribute of an image the user wishes to retrieve;
receiving user responses; and
presenting at least one image to the user based upon the user response.

2. The method of claim 1, wherein the step of querying a user comprises posing a series of questions to the user and wherein the step of receiving the user response comprises receiving separate responses to each posed question.

3. The method of claim 2, wherein at least one of the successive questions depends upon the user response given to a previous question.

4. The method of claim 1, further comprising the step of eliminating potential image matches in response to the received response.

5. The method of claim 1, further comprising the step of prompting the user to identify at least one image attribute.

6. The method of claim 5, further comprising the step of storing an attribute association as image metadata in response to a user response to the prompting of the user.

7. The method of claim 6, wherein the user response to the prompting comprises direct user selection of at least one presented image.

8. The method of claim 6, wherein the user response to the prompting comprises user identification of at least one image attribute in at least one presented image.

9. The method of claim 1, further comprising the step of analyzing images for a recognizable image attribute.

10. The method of claim 9, further comprising the step of storing attribute associations as image metadata based upon the analyzing of the images.

11. An image retrieval system, comprising:
means for querying a user as to attributes of an image the user wishes to retrieve;
means for receiving user responses; and
means for presenting images to the user based upon the user responses.

12. The system of claim 11, further comprising means for prompting the user to identify image attributes.

13. The system of claim 12, further comprising means for storing an attribute association as image metadata in response to a user response to the prompting of the user.

14. The system of claim 11, further comprising means for analyzing images for a recognizable image attribute.

15. The system of claim 14, further comprising means for storing attribute associations as image metadata based upon the analyzing of the images.

16. A computer program stored on a computer-readable medium, comprising:
logic configured to generate questions for a user that are designed to elicit responses as to attributes of an image the user wishes to retrieve;
logic configured to receive user responses; and
logic configured to determine which images may satisfy the user's retrieval wishes.

17. The program of claim 16, further comprising logic configured to prompt the user to identify image attributes.

18. The program of claim 17, further comprising logic configured to store an attribute association as image metadata in response to a user response to the prompting of the user.

19. The program of claim 16, further comprising logic configured to analyze images for a recognizable image attribute.

20. The program of claim 19, further comprising logic configured to store attribute associations as image metadata based upon the analyzing of the images.
